(19) United States
(12) Patent Application Publication
(10) Pub. No.: US 2007/0223419 A1
(43) Pub. Date: Sep. 27, 2007

(54) METHOD AND SYSTEM FOR SHARING SPECTRUM IN A WIRELESS COMMUNICATIONS NETWORK

(75) Inventors: Baowei Ji, Plano, TX (US); Yinong Ding, Plano, TX (US); William Joseph Semper, Richardson, TX (US)

Correspondence Address: FOGG & POWERS LLC, 10 SOUTH FIFTH STREET, SUITE 1000, MINNEAPOLIS, MN, 55402, US

(73) Assignee: Samsung Electronics Co., Ltd., Suwon-city (KR)

(21) Appl. No.: 11/671,159

(22) Filed: Feb. 5, 2007

Related U.S. Application Data
(60) Provisional application No. 60/785,553, filed on Mar. 24, 2006.

(51) Int. Cl. H04Q 7/00

(52) U.S. Cl. 370/329

(57) ABSTRACT

A method and system for sharing spectrum in a wireless communications network are disclosed. As one example, a method for sharing spectrum is disclosed, which includes the steps of determining if two base stations in the wireless communications network are to share a frequency spectrum, and if two base stations in the wireless communications network are to share a frequency spectrum, determining if the two base stations in the wireless communications network have non-overlapping wireless communications coverage. Also, if the two base stations in the wireless communications network have non-overlapping wireless communications coverage, determining if a first mobile communications unit associated with a first base station of the two base stations has wireless communications coverage that overlaps with wireless communications coverage of a second mobile communications unit associated with a second base station of the two base stations, and if the first mobile communications unit has wireless communications coverage that overlaps with wireless communications coverage of the second mobile communications unit, enabling the two base stations to use a synchronized parallel operation spectrum sharing mode for communications. Also, a Contention-for-being-Master approach is disclosed as one primary method for sharing spectrum, which can be treated separately from all other contention methods, or combined with the exemplary contention method disclosed herein.

### CROSS-REFERENCE TO RELATED APPLICATION AND CLAIM FOR PRIORITY

The present application is related to U.S. Provisional Patent Application No. 60/785,553, entitled “CHANNEL SHARING METHOD FOR INTER-CELL COEXISTENCE,” filed on Mar. 24, 2006, which is assigned to the assignee of the present application. The subject matter disclosed in U.S. Provisional Patent Application No. 60/785,553 is incorporated by reference into the present application as if fully set forth herein. The present application hereby claims priority, under 35 U.S.C. §119(e), to U.S. Provisional Patent Application No. 60/785,553.

### FIELD OF THE INVENTION

The invention relates to the telecommunications field, and more particularly, but not exclusively, to a method and system for sharing spectrum in a wireless communications network.

### BACKGROUND OF THE INVENTION

The primary goal of the IEEE 802.22 Working Group on Wireless Regional Area Networks (WRANs) is to develop a standard for a Cognitive Radio-(CR)-based Physical Layer/Medium Access Control (PHY/MAC) air interface for use by license-exempt wireless communication devices on a non-interfering basis in a frequency spectrum allocated to the television broadcast services. Specifically, the IEEE 802.22 Working Group is tasked to develop the specifications for a fixed point-to-multipoint WRAN that will utilize specific television channels and guard bands for communications in the UHF and VHF television bands.

A significant problem yet to be resolved by the IEEE 802.22 Working Group is the issue of inter-cell coexistence. In CR-based networks, the issue of inter-cell coexistence arises whenever two or more neighbor cells attempt to share the same television spectrum (e.g., channel). For example, in Wireless Metropolitan Area Networks (WMANs) operated in accordance with the IEEE 802.16d/e Broadband Wireless Access standard, by suitable site pre-planning beforehand, neighbor Base Stations (BSs)/cells may use different pseudo-noise (PN) sequences in the preambles of their signaling messages to protect them from collisions. Also, under the 802.16d/e standard, the neighbor BSs/cells may use different permutation methods to protect the Frame Control Headers (FCHs), downlink-(DL-)MAPs, and uplink-(UL-)MAPs in their signaling messages, in order to convey essential information to the Customer Premises Equipment (CPEs) associated with each BS/cell involved. In other words, under the existing 802.16d/e standard, with suitable pre-planning, the neighbor cells are allowed to use different PN sequences for both cell identification (ID) and frequency reuse mapping purposes.

Notwithstanding the numerous advantages of the 802.16d/e standard, a significant problem that exists with 802.16d/e is that it requires the BSs to use the Partial Usage of Sub-Channels (PUSC) mode of operation (i.e., FDM) to transmit signaling messages, which can include DL preambles, FCHs, DL-MAPs and UL-MAPs. However, under the existing 802.22 standard, CR-based systems are required to use dynamic frequency selection for channel allocation purposes. Consequently, for CR-based systems, suitable pre-planning is not available for the network BSs to determine in advance which PN sequences or permutation tables to use for their channel allocation signaling messages. Thus, it is possible that the neighbor cells in CR-based systems may use the same PN sequences in their respective signaling messages, which will result in preamble collisions. In other words, the 802.16d/e standard requires the use of the PUSC mode to transmit signaling messages, but the PUSC mode cannot be directly implemented in those CR-based systems where dynamic frequency selection/allocation has to be used. This type of problem can be referred to as an inter-cell coexistence problem. An example of such an inter-cell coexistence problem is illustrated in FIGS. 1 and 2.

Referring to FIG. 1, a relatively simple wireless network 100 is shown, which includes two BSs 102 and 104 (e.g., operating under 802.16d/e) and their respective cell coverage areas 110 and 112. Cell overlap for the two BSs 102, 104 is shown as coverage area 114. Two CPE units 106 and 108 are located within the overlapping cell coverage area 114. Referring also to diagram 200 shown in FIG. 2, assume that network 100 in FIG. 1 is required to use dynamic frequency selection (e.g., in accordance with the 802.22 standard), and as a consequence, the preamble in frame 202 of a signaling message transmitted from BS 102 to CPE unit 108 is shown colliding (206) with the preamble in frame 204 transmitted from BS 104 to CPE unit 106. In other words, with dynamic frequency selection, the neighbor BSs 102 and 104 can end up using the same PN sequence in their respective signaling messages, which will cause preamble collisions for the signaling messages involved. Thus, a need exists for a method whereby neighboring BSs in a CR-based system can use different PN sequences dynamically in their respective signaling messages, without the need for site pre-planning beforehand.

FIG. 3 is a block diagram 300 showing a plurality of downlink signaling messages being transmitted using a PUSC mode of operation, which further explains why collisions can occur if the methods in 802.16d/e are used directly for systems with dynamic frequency selection (e.g., 802.22). In a downlink PUSC transmission (e.g., frame 302), there are 3 major groups (e.g., channels) 302a-302c and 3 secondary groups (e.g., sub-channels, sub-carriers) available for allocation. As such, a BS can allocate one major group plus 0 to 3 secondary groups to a neighbor cell or cell sector. For example, frame 304 illustrates the allocation of channels (e.g., 304a, 304b, 304c) and sub-channels 304d, 306, 308, 310 that can be allocated to a neighbor cell (indicated as block 312). The problem illustrated by FIG. 3 is that by using the PUSC mode in a CR-based network, if two neighboring BSs attempt to use the same major group in their respective signaling messages, serious inter-cell interference may exist that can prohibit some of the CPEs from receiving the downlink messages involved. Thus, a need exists for a channel sharing approach whereby neighboring BSs in a CR-based system can dynamically select different major groups in their respective signaling messages. Similarly, a need exists for a channel sharing approach whereby neighboring cell sectors can use different PN sequences in disjoint sub-carriers.

Another significant problem exists with the current 802.22 standard, which includes a mandatory inter-BS communication protocol called the Coexistence Beacon Protocol (CBP). The CBP is designed for multiple neighboring BSs to use the same TV channel at the same time, by allocating disjoint frequency-time slots to overlapping CPEs. However, in the proposed 802.22 specification, the preambles and frame header could still collide, and the CPEs have not been provided with specific techniques for decoding the BSs' preambles and MAP messages. In other words, there is a significant design flaw with the current CBP proposal in the 802.22 standard.

### SUMMARY OF THE INVENTION

In a first example embodiment, a method for sharing spectrum in a wireless communications network is provided. The method includes the steps of determining if two base stations in the wireless communications network are to share a frequency spectrum, and if two base stations in the wireless communications network are to share a frequency spectrum, determining if the two base stations in the wireless communications network have non-overlapping wireless communications coverage. Also, if the two base stations in the wireless communications network have non-overlapping wireless communications coverage, determining if a first mobile communications unit associated with a first base station of the two base stations has wireless communications coverage that overlaps with wireless communications coverage of a second mobile communications unit associated with a second base station of the two base stations, and if the first mobile communications unit has wireless communications coverage that overlaps with wireless communications coverage of the second mobile communications unit, enabling the two base stations to use a synchronized parallel operation spectrum sharing mode for communications.

In a second example embodiment, a method for neighbor cells to share a channel in a cognitive radio-based communications network is provided. The method includes the steps of determining if at least two cells in the network have overlapping radio coverage, if at least two cells in the network have overlapping radio coverage, a first cell of the at least two cells determining if a second cell of the at least two cells intends to use a predetermined channel sharing mode for communications, and if the second cell intends to use the predetermined channel sharing mode, enabling the first cell to use the predetermined channel sharing mode for communications. Also, if the at least two cells in the network do not have overlapping radio coverage, determining if the at least two cells have associated customer premises equipment units that have overlapping radio coverage, and if the at least two cells have associated customer premises equipment units that have overlapping radio coverage, enabling the at least two cells to use a synchronized parallel operation channel sharing mode of communications.

In a third example embodiment, a system for sharing spectrum in a wireless communications network is provided. The system includes a first base station arranged in the wireless communications network, a first customer premises equipment unit coupled to the first base station by a first radio air interface, a second base station arranged in the wireless communications network, and a second customer premises equipment unit coupled to the second base station by a second radio air interface. The first base station is configured to determine if the first base station and the second base station are to share a frequency spectrum, if the first base station and the second base station are to share a frequency spectrum, determine whether or not the first radio air interface and the second radio air interface overlap in communications coverage, if the first radio air interface and the second radio air interface overlap in communications coverage, determine if the second base station intends to use a predetermined channel sharing mode for communications, and if the second base station intends to use the predetermined channel sharing mode for communications, use the predetermined channel sharing mode for communications.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIGS. 1 and 2 depict related block diagrams that illustrate examples of inter-cell coexistence problems that currently exist;

FIG. 3 depicts a block diagram showing a plurality of downlink signaling messages being transmitted using a PUSC mode of operation, which further illustrates an example of an inter-cell coexistence problem that currently exists;

FIG. 4 depicts a flowchart representing an exemplary method for sharing spectrum in a wireless communications network, which can be used to implement an example embodiment of the present invention;

FIG. 5 depicts a simplified block diagram that illustrates a Synchronized Parallel Operation approach that may be used for channel sharing by two BSs with non-overlapping cell coverage and overlapping CPE coverage, in accordance with one example embodiment of the present invention;

FIG. 6 depicts a simplified block diagram that illustrates a Partially Interlaced Operation channel sharing approach that may be used by a first BS with overlapping cell coverage with a neighbor BS, in accordance with a second example embodiment of the present invention; and

FIG. 7 depicts a simplified block diagram that illustrates a Partially Utilized Sub-Carriers channel sharing approach that may be used by a first BS with overlapping cell coverage with a neighbor BS, in accordance with a third example embodiment of the present invention.

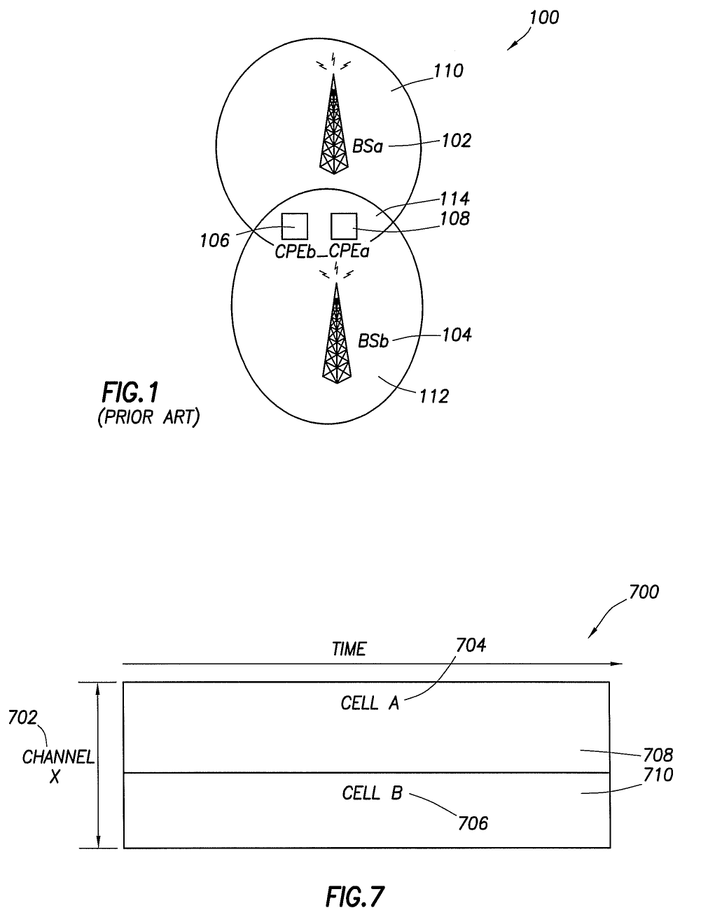

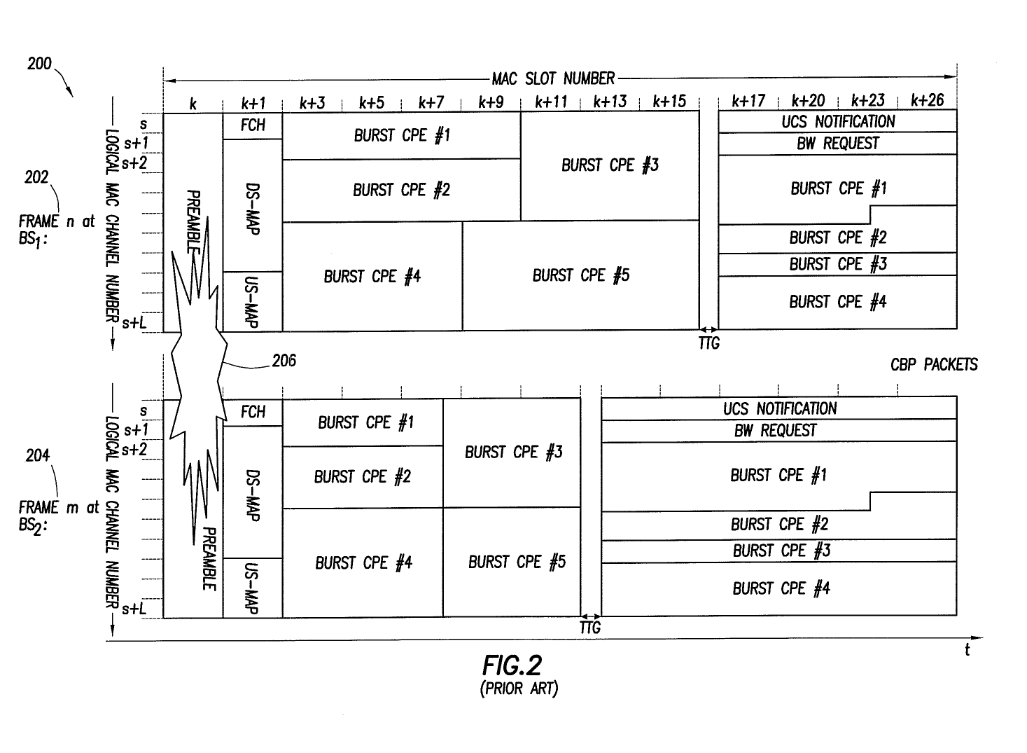

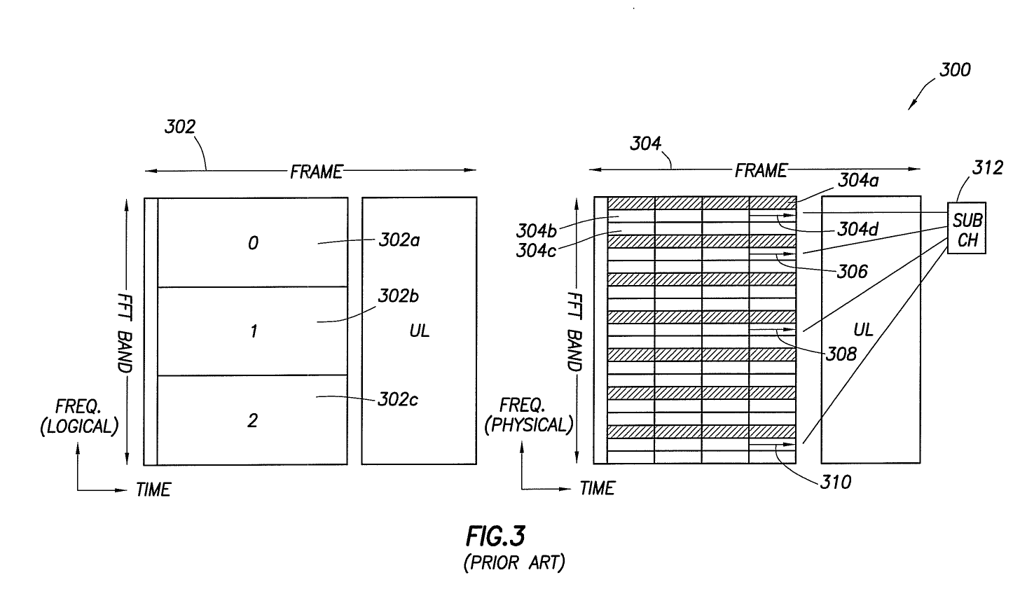

### DETAILED DESCRIPTION OF PREFERRED EMBODIMENT

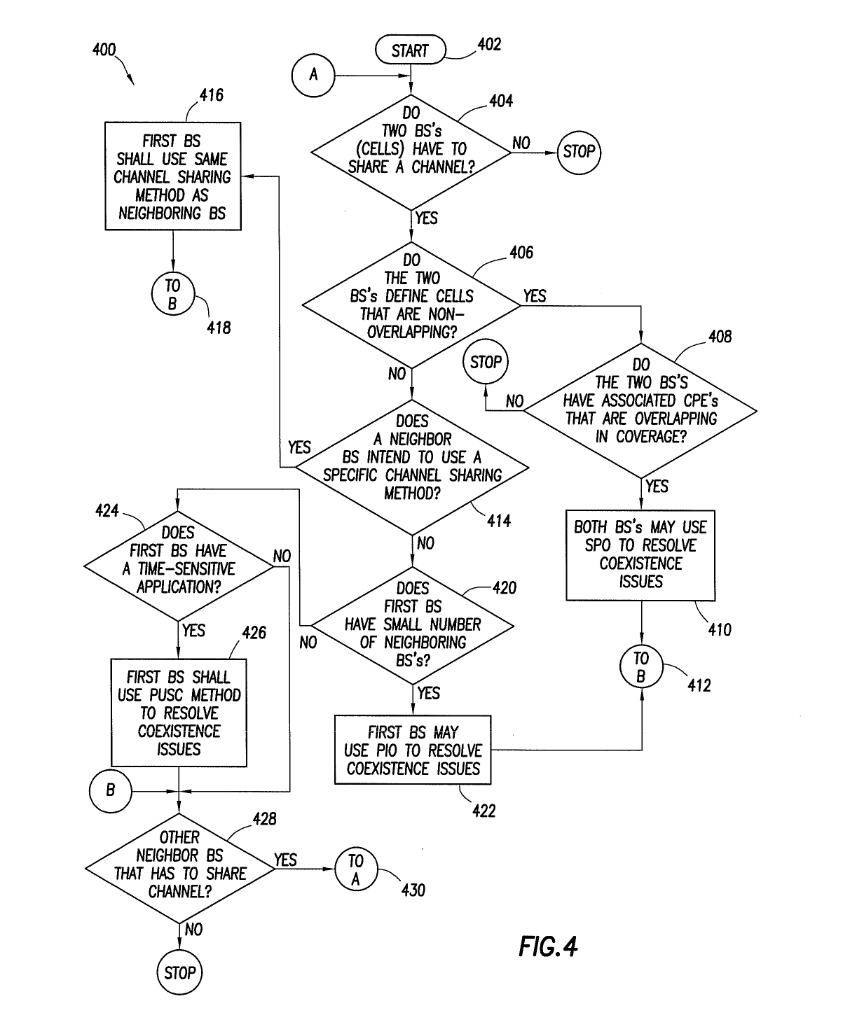

Notably, for those systems using dynamic frequency selection under the current 802.22 standard, the collisions of preambles and headers in the signaling messages from neighbor BSs will prohibit coexistence between neighbor cells and/or sectors. The present invention provides a method and system for spectrum sharing and inter-cell coexistence in a wireless communications network, which resolves the dynamic frequency selection issue and enables the neighboring BSs to resolve their coexistence problems by themselves. In a first example embodiment, the neighbor BSs in a wireless communications network can contend over the air interface (or backhaul network) to become a master BS. The master BS can then decide for the neighbor BSs, which BS will use which PN sequence and sub-channelization configuration. This approach maintains the proposed PUSC sub-channelization structure and the receiver design of CPEs, and also resolves the collision problem resulting from the dynamic frequency selection requirement of 802.22. Also, this approach does not rely on site pre-planning and the pre-assignment of PN sequences and sub-channelization for each neighbor BS. This Contention-for-being-Master approach is one primary method for sharing spectrum, which can be treated separately from all other spectrum sharing methods, or combined with the exemplary method described below with respect to FIG. 4.

In a second example embodiment, a method is provided for spectrum sharing and inter-cell coexistence in a wireless communications network. For the preambles in their signaling messages, the neighbor BSs/cells may use different PN sequences. Also, if applicable, the neighbor sectors within a cell may use different PN sequences, as well as disjoint sub-carriers (e.g., in the PUSC mode) to avoid intra-cell interference. For the FCH and downlink-MAP and uplink-MAP components in their signaling messages, the neighbor BSs/cells and neighboring sectors of different cells (if applicable) may use different sub-channelization configurations, in order to minimize inter-cell interference.

With reference now to the figures, FIG. 4 depicts a flowchart representing an exemplary method 400 for sharing spectrum in a wireless communications network, which can be used to implement an example embodiment of the present invention. For example, method 400 can be used to determine how neighbor cells in a wireless communications network can share one spectrum resource (e.g., frequency band, sub-band, channel, carrier, sub-carrier, etc.). In one example embodiment, method 400 can be used to determine how neighbor cells in a CR-based wireless communications network can share one television channel.

Referring to FIG. 4 for this example embodiment, method 400 can begin a channel sharing procedure when two or more neighbor BS's/cells determine that they will have to share a channel. For example, the network may not have enough disjoint channels available for all of the BS's/cells/sectors involved. For clarity and ease of understanding, it may be assumed that a cell of interest whose coverage is defined by a first BS (e.g., BSa), is attempting to share a channel (e.g., channel X) with a neighbor cell whose coverage is defined by a second BS (e.g., BSb). Thus, for this example embodiment, method 400 first determines whether or not two BSs/cells have to share a channel (step 404). Notably, as described below, method 400 can be reiterated to provide channel sharing for the first BS/cell (e.g., BSa) and additional BSs/cells. In any event, if (at step 404) it is determined that there are not two BSs/cells in the network that have to share a channel, then method 400 may be terminated.

However, if (at step 404) it is determined that two BSs/cells have to share a channel, then method 400 next determines whether or not those two cells overlap in coverage (step 406). If (at step 406) it is determined that the two BSs (e.g., BSa and BSb) have cell coverage that is non-overlapping, method 400 then determines whether or not the two BSs have associated CPEs (e.g., CPEa and CPEb, respectively) whose communications coverage is overlapping (step 408). In this case, it is possible for the two CPEs to hear each other and thus interfere with each other's communications, even though there is no overlap in the coverage areas of the CPEs' associated cells. Notably, a coexistence issue arises because a collision can occur if one CPE is receiving while the other CPE is transmitting, and they are both using the same sub-carriers. Thus, if method 400 determines that the cell coverage for the two BSs involved (e.g., BSa and BSb) is not overlapping, but the two BSs have CPEs whose communications coverage areas overlap, then the two BSs (e.g., BSa and BSb) may use a Synchronized Parallel Operation (SPO) mode of operation for channel sharing (described below), in order to resolve the coexistence issues that may arise (step 410). The flow then proceeds to connector B (step 412). Alternatively, if (at step 408) the two BSs have associated CPEs whose coverage areas do not overlap, then there is not coexistence issue to resolve, and method 400 may be terminated.

FIG. 5 depicts a simplified block diagram that illustrates an SPO approach 500 that may be used for channel sharing by two BSs with non-overlapping cell coverage and overlapping CPE coverage, in accordance with one example embodiment of the present invention. As shown in FIG. 5, both BSa 506 and BSb 512 can share the same channel (X) 502, because the coverage areas of their respective cells 504 and 510 do not overlap. Consequently, the potential for collisions of the DL preambles, FCHs, DL-MAPs or UL-MAPs in the respective signaling messages transmitted from these BSs is eliminated because of the non-overlapping cell coverage. Notably, in this case, BSa 506 and BSb 512 can perform inter-BS communications and synchronize with each other through their respective CPEa 508 and CPEb 514. Also, advantageously, note that implementation of this SPO approach is relatively simple, and one channel may be shared and utilized by both BSs in parallel. The SPO approach maximizes spectrum utilization with a moderate amount of implementation complexity. Conversely, using the SPO approach in this case, in order to be able to share channel X simultaneously, the two cells involved (504 and 510) have to be synchronized, and the structure of the message inside the transmitted frame is fixed. For example, in Wireless Broadband (WiBro) systems, the lengths of the DL bursts (DBs) and UL bursts (UBs) are fixed. Note that both the Transmit/receive Transition Gap (TTG) and Receive/transmit Transition Gap (RTG) should include appropriate guard time to accommodate the different propagation delays from the two BSs at their overlapping area.

Returning to step 406 in FIG. 4, if the two BSs involved have cells with overlapping coverage, then the first BS determines whether or not the neighbor BS intends to use a specific channel sharing approach (step 414). For example, if the neighbor BS (e.g., BSb) intends to use a contention-based channel sharing approach, a PUSC channel sharing approach, or a Partially Interlaced Operation (PIO) channel sharing approach, then the first BS (e.g., BSa) shall use the same channel sharing approach as that used by the neighbor BS (step 416). The flow then proceeds to connector B (step 418).

Returning to step 414, if the first BS determines that the neighbor BS does not intend to use a specific channel sharing approach, then the first BS determines whether or not the network includes a relatively small number (e.g., no more than 3) of neighboring BSs (step 420). If (at step 420) the first BS determines that the network includes a small number of neighboring BSs, then the first BS may use a PIO channel sharing approach (step 422), which is described below, to resolve the coexistence issues that may arise. The flow then proceeds to connector B (step 412).

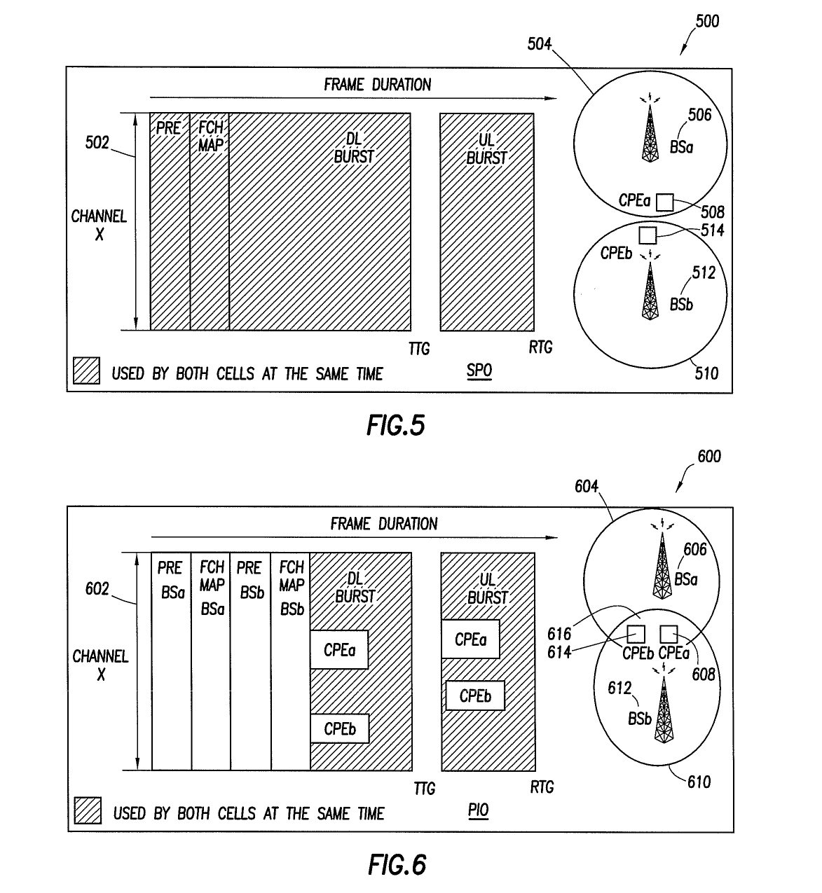

FIG. 6 depicts a simplified block diagram that illustrates a PIO channel sharing approach 600 that may be used by a first BS with overlapping cell coverage with a neighbor BS, in accordance with a second example embodiment of the present invention. For this example embodiment, as shown in FIG. 6, using a PIO channel sharing approach, both BSa 606 and BSb 612 can share the same channel X 602 because the coverage areas of their respective cells 604 and 610 overlap (e.g., coverage area 616). Note that during the duration of one frame, the first BSa 606 can transmit a signaling message on a DL burst via channel X 602, which includes a DL preamble, FCH, and MAP message intended for the associated CPEa 608. Also, during the same frame duration, a neighbor BSb 612 can also transmit a signaling message on a DL burst via channel X 602, which also includes a DL preamble, FCH, and MAP message intended for the associated CPEb 614. Additionally, during the same frame duration, each CPEa 608, CPEb 614 can communicate with its associated BSa 606, BSb 612, respectively, on an UL burst. Consequently, as illustrated by the PIO channel sharing approach 600 shown in FIG. 6, if a relatively small number of neighbor BSs is involved, the potential for collisions of the DL preambles, FCHs, DL-MAPs or UL-MAPs in the respective signaling messages transmitted from these BSs and their respective CPEs can be eliminated with a PIO channel sharing approach, because of the overlapping cell coverage of the small number of BSs and/or CPEs.

Notably, for those cases where overlapping cell coverage is provided, the PIO channel sharing approach shown in FIG. 6 illustrates that if a suitable number of time slots and sub-carriers can be provided, a signal channel may be utilized by a plurality of BSs in parallel. However, using the PIO approach in this case, in order to be able to share the signal channel (X) simultaneously, the two cells involved (604 and 610) have to be synchronized, and the structure of the message inside the transmitted frame is fixed. As mentioned above, in Wireless Broadband (WiBro) systems, for example, the lengths of the DL bursts and UL bursts are fixed.

Returning to step 420 in FIG. 4, if the first BS determines that the network includes a relatively large number of neighboring BSs (e.g., more than 3 neighboring BSs), then the first BS may determine whether or not it and/or its associated CPE has a time-sensitive application that is waiting to be performed (step 424). For example, the first BS may have a Voice over Internet Protocol (VoIP) application or IP television (IPTV) application that is waiting to be performed. If (at step 424) the first BS determines that it and/or its associated CPE has a time-sensitive application that is waiting to be performed, then the first BS shall use a PUSC channel sharing approach (described below) with the neighbor BS involved (step 426). Otherwise, if (at step 424) the first BS determines that it and/or its associated CPE do not have a time-sensitive application that is waiting to be performed, the flow proceeds to step 428. At step 428, the first BS can determine whether or not there are additional BSs that may want to share the same channel (or spectrum resource). If so, then the flow returns to step 404, and method 400 can be re-performed for the first BS and a second neighboring BS (and so on). If not, then the channel sharing steps of method 400 can be terminated.

FIG. 7 depicts a simplified block diagram that illustrates a PUSC channel sharing approach 700 that may be used by a first BS with overlapping cell coverage with a neighbor BS, in accordance with a third example embodiment of the present invention. For this example embodiment, as shown in FIG. 7, using a PUSC channel sharing approach, two neighbor cells (e.g., cell A 704, cell B 706) can share the same channel X 702 because their respective coverage areas overlap, and a suitable number of sub-carriers 708 and 710 (e.g., 2 sub-carriers in this case) are available for the neighbor cells involved. Note that the PUSC channel sharing approach can be implemented relatively simply. Also, using the PUSC approach, a certain channel (e.g., channel X 702) is always made available for two (or more) neighbor cells to use. Furthermore, an advantage of using the PUSC channel sharing approach is that no synchronization of the neighboring cells is required. Conversely, the PUSC channel sharing approach requires the allocations of the sub-carriers to be fixed, and the neighbor BSs involved are required to negotiate with each other to determine what portion of the available resource (channel) each cell can use.

Essentially, there are numerous cell/CPE co-location scenarios that can exist. In that regard, the cases that require the use of the above-described channel sharing approaches to resolve coexistence issues can be summarized as follows. In one case, the neighbor BSs have cells that overlap, and each cell region includes an associated CPE. Consequently, the two BSs have to resolve the coexistence issue if they have to share a channel. The associated CPEs can hear both BSs. Consequently, the downlink transmissions from the two BSs can collide at each CPE. Also, a BS can hear any CPE located in the overlapped region. Consequently, the uplink transmissions from two CPEs can collide at a BS. So, the major issue is to protect the transmissions in both directions. Whether or not the CPEs in the overlapping regions can hear each other is not an issue with respect to coexistence design.

In a second case, the neighboring BSs have non-overlapping cells, but the communications coverage of their associated CPEs overlap. Consequently, the two CPEs associated with the different BSs can hear and interfere with each other, even if there is no overlapping coverage between the two BSs. In this case, collisions can occur when one CPE is receiving while the other CPE is transmitting, and the two CPEs are using the same sub-carriers. The coexistence issue in this case is not as severe as the coexistence issue in the first case.

Note that there are additional scenarios that can fall within the two cases described above. For example, if two CPEs with overlapping coverage are outside the overlapping region of their associated cells, then this case is essentially the second case described above. As another example, if a CPE uses a directional antenna that is pointed towards its associated BS, then that CPE may not be affected by transmissions from a second BS, even if the two BSs have cells with overlapping coverage. The same situation exists if a second CPE (that can hear the first CPE) uses a directional antenna that is pointed towards its associated BS, then that CPE may not be affected by transmissions from the first BS, even though the two BSs have cells with overlapping coverage. Again, this case is essentially the second case described above.

Also, note that the above-described two cases are not limited to two BSs or two CPEs. With suitable power control provided in each cell, there is no coexistence issue that arises for the following two cases: (1) the cells and the CPEs associated with the different cells do not have overlapping coverage; and (2) the cells have overlapping coverage, but there are no CPEs located within the overlapping regions.

There is another operational mode that can be used to resolve coexistence issues that also should be described. The Virtually Asynchronous Operation (VAO) mode can be used for channel sharing when there are overlapping cells. However, in the VAO mode, synchronization between the BSs involved is required, or inter-cell coexistence is extremely difficult, if not impossible, to achieve, considering the high probability of collisions (at each CPE) of the preambles, MAPs, and DL bursts, and the collisions (at each BS) of the UL bursts. For the non-overlapping cell cases, the decision making at one BS can be accomplished by having that BS's associated CPE not transmit while the CPE associated with the other BS is receiving a DL burst. Also, that BS can schedule its associated CPE's receiving periods to be different from the transmitting periods of the other BS's associated CPE. Note that in using the VAO mode, the two BSs are not required to transmit their frames with a strictly synchronous method. However, in using the VAO mode, each BS needs to know the exact timing of the other BS and operate accordingly. As a matter of fact, the VAO approach is still a synchronized type of operation. The VAO approach can be seriously limited when there are numerous overlapped CPEs having the above-described transmission and reception constraints.

The description of the present invention has been presented for purposes of illustration and description, and is not intended to be exhaustive or limited to the invention in the form disclosed. Many modifications and variations will be apparent to those of ordinary skill in the art. These embodiments were chosen and described in order to best explain the principles of the invention, the practical application, and to enable others of ordinary skill in the art to understand the invention for various embodiments with various modifications as are suited to the particular use contemplated.

What is claimed is:

1. A method for sharing spectrum in a wireless communications network, comprising the steps of:
determining if two base stations in the wireless communications network are to share a frequency spectrum;
if two base stations in the wireless communications network are to share a frequency spectrum, determining if the two base stations in the wireless communications network have non-overlapping wireless communications coverage;
if the two base stations in the wireless communications network have non-overlapping wireless communications coverage, determining if a first mobile communications unit associated with a first base station of the two base stations has wireless communications coverage that overlaps with wireless communications coverage of a second mobile communications unit associated with a second base station of the two base stations; and
if the first mobile communications unit has wireless communications coverage that overlaps with wireless communications coverage of the second mobile communications unit, enabling the two base stations to use a synchronized parallel operation spectrum sharing mode for communications.

2. The method of claim 1, further comprising the steps of:
if the two base stations in the wireless communications network do not have non-overlapping wireless communications coverage, determining if the second base station is enabled to use a predetermined spectrum sharing mode for communications; and
if the second base station is enabled to use the predetermined spectrum sharing mode for communications, enabling the first base station to use the predetermined spectrum sharing mode for communications.

3. The method of claim 1, further comprising the steps of:
if the two base stations in the wireless communications network do not have non-overlapping wireless communications coverage, determining if the second base station is enabled to use a predetermined spectrum sharing mode for communications;
if the second base station is not enabled to use the predetermined spectrum sharing mode for communications, determining if the wireless communications network includes a predetermined number of neighbor base stations associated with the first base station; and
if the wireless communications network includes the predetermined number of base stations associated with the first base station, enabling the first base station to use a partially interlaced operation spectrum sharing mode for communications.

4. The method of claim 1, further comprising the steps of:
if the two base stations in the wireless communications network do not have non-overlapping wireless communications coverage, determining if the second base station is enabled to use a predetermined spectrum sharing mode for communications;
if the second base station is not enabled to use the predetermined spectrum sharing mode for communications, determining if the wireless communications network includes a predetermined number of neighbor base stations associated with the first base station;
if the wireless communications network does not include the predetermined number of base stations associated with the first base station, determining if the first base station has a time-sensitive application to be executed; and
if the first base station has a time-sensitive application to be executed, enabling the first base station to use a partially utilized sub-carriers spectrum sharing mode for communications.

5. The method of claim 1, wherein the frequency spectrum comprises at least one of a frequency band, a sub-band, a channel, a sub-channel, a carrier, and a sub-carrier.

6. The method of claim 1, wherein the frequency spectrum comprises a television channel, and the wireless communications network comprises a Cognitive Radio-(CR)-based network.

7. The method of claim 1, wherein the first base station and the second base station comprise a plurality of neighbor base stations or neighbor cells.

8. The method of claim 1, wherein the first mobile communications unit comprises a first customer premises equipment unit and the second mobile communications unit comprises a second CPE unit.

9. The method of claim 2, wherein the predetermined spectrum sharing mode comprises at least one of a contention-based spectrum sharing mode, a partially utilized sub-carriers spectrum sharing mode, and a partially interlaced operation spectrum sharing mode.

10. The method of claim 3, wherein the predetermined number of base stations comprises three, two or one base stations.

11. A method for neighbor cells to share a channel in a cognitive radio-based communications network, comprising the steps of:
determining if at least two cells in the network have overlapping radio coverage;
if at least two cells in the network have overlapping radio coverage, a first cell of the at least two cells determining if a second cell of the at least two cells intends to use a predetermined channel sharing mode for communications, and if the second cell intends to use the predetermined channel sharing mode, enabling the first cell to use the predetermined channel sharing mode for communications; and
if the at least two cells in the network do not have overlapping radio coverage, determining if the at least two cells have associated customer premises equipment units that have overlapping radio coverage, and if the at least two cells have associated customer premises equipment units that have overlapping radio coverage, enabling the at least two cells to use a synchronized parallel operation channel sharing mode of communications.

12. The method of claim 11, further comprising the steps of:
if the second cell does not intend to use the predetermined channel sharing mode, determining if the first cell has a predetermined number of neighboring cells; and
if the first cell has the predetermined number of neighboring cells, enabling the first cell to use a partially utilized operation channel sharing mode of communications with at least one of the neighboring cells.

13. The method of claim 11, further comprising the steps of:
if the second cell does not intend to use the predetermined channel sharing mode, determining if the first cell has a predetermined number of neighboring cells; and
if the first cell does not have the predetermined number of neighboring cells, enabling the first cell to use a partially utilized sub-carriers channel sharing mode of communications with at least one of the neighboring cells.

14. A system for sharing spectrum in a wireless communications network, comprising:
a first base station arranged in the wireless communications network;
a first customer premises equipment unit coupled to the first base station by a first radio air interface;
a second base station arranged in the wireless communications network; and
a second customer premises equipment unit coupled to the second base station by a second radio air interface, wherein the first base station is configured to:
determine if the first base station and the second base station are to share a frequency spectrum;
if the first base station and the second base station are to share a frequency spectrum, determine whether or not the first radio air interface and the second radio air interface overlap in communications coverage;
if the first radio air interface and the second radio air interface overlap in communications coverage, determine if the second base station intends to use a predetermined channel sharing mode for communications, and if the second base station intends to use the predetermined channel sharing mode for communications, use the predetermined channel sharing mode for communications.

15. The system of claim 14, wherein the first base station is further configured to:
determine if the first customer premises equipment unit is coupled for communications to the second customer premises equipment unit, if the first radio air interface and the second radio air interface do not overlap in communications coverage; and
use a synchronized parallel operation channel sharing mode for communications with the second base station.

16. The system of claim 15, further comprising:
a third base station, the third base station including a third radio air interface coupled for communications with the first radio air interface and the second radio air interface;
wherein the first base station is further configured to:
use a partially interlaced operation channel sharing mode for communications with at least one of the second base station and the third base station.

17. The system of claim 14, wherein the wireless communications network comprises a communications network configured to operate in accordance with the 802.22 Working Group standard.

18. The system of claim 14, wherein the spectrum comprises at least one of a band, sub-band, channel, sub-channel, carrier, and sub-carrier.

19. The system of claim 14, wherein the spectrum comprises a channel within a frequency band substantially between 54 MHz and 862 MHz.

20. The system of claim 14, wherein the wireless communications network is configured to operate in accordance with the IEEE 802.16d/e standard.
